(19) United States
(12) Patent Application Publication
(10) Pub. No.: US 2017/0312752 A1
(43) Pub. Date: Nov. 2, 2017

(54) APPARATUS FOR COMMINUTING ORE, COMPRISING A HYDRAULIC SPRING DEVICE, AND ASSOCIATED METHOD

(71) Applicant: Micro Impact Mill Limited, Fürstentum (LI)

(72) Inventor: Parviz GHARAGOZLU, Santiago Centro (CL)

(21) Appl. No.: 15/517,828

(22) PCT Filed: Oct. 8, 2015
(86) PCT No.: PCT/EP2015/073235

§ 371 Date: Jul. 26, 2017

(30) Foreign Application Priority Data
Oct. 9, 2014 (DE) 10 2014 014 945.5

(51) Int. Cl. B02C 7/06; B02C 7/16; B02C 7/12; B02C 7/14; B02C 23/12; B02C 19/00

(52) U.S. Cl. CPC B02C 7/06; B02C 23/12; B02C 19/005; B02C 7/12; B02C 7/14; B02C 7/16

(57) ABSTRACT

A device for comminuting ore and/or slag is contemplated. The device may be comprising an ore feeding unit for feeding ore which is to be comminuted to a first pulverizer, said first pulverizer being composed of at least of two comminuting elements which can be moved relative to each other, said elements forming together at least one comminuting space for the ore which is to be comminuted, such that, by a relative movement in the form of a rotation about the rotational axis of at least one of the two comminuting elements the ore which is to be comminuted is at least partially pulverized. One or more accelerating elements, in particular protrusions, are provided on at least one of the comminuting elements, said accelerating elements being arranged in particular on the end face of at least one of the two comminuting elements and accelerating and comminuting the ore to be comminuted by the rotation of one of the two comminuting elements. An intermediate space is provided between the two comminuting elements and/or in at least one of the two comminuting elements, through which space the pulverized ore, during the rotation, is transported from the center of rotation toward the outside and away from the two comminuting elements. At least one of the two comminuting elements is operatively connected to a hydraulic spring pressure device, said hydraulic spring pressure device being designed such that the comminuting element to which it is operatively connected is variably resiliently mounted in the direction of the other comminuting element depending on an adjustable hydraulic spring pressure control unit.

### TECHNICAL FIELD

The invention at hand relates to a method as well as to a device for comminuting ore material or rocks, respectively, and/or slag, wherein the ore is pulverized in a particularly ecological manner with the use of water in the wet method or also without the use of water in the dry method.

According to the Fraunhofer Institute, the human race will consume 140 billion tons of minerals, ores, fossil fuels and biomass annually in the year 2050. Today, we consume a third thereof. Raw materials become the key in global competition, in particular for the mining industry. “Minimize energy and raw material consumption” is the motto for the industry. Energy-efficient innovations are one step to conserve resources and simultaneously a chance to change the economy and to provide lasting stimuli.

The mining industry plays a strategic role in the production of raw materials. Procedural improvements are the first step for a plurality of resource use instead of resource consumption.

In the case of the production of raw materials, there is thus also a great need to utilize environmentally friendly methods and devices, in order to in particular also protect the persons involved therein against damages caused to their health. In the case of the common comminution of ore material, the health of the persons employed by the mining industry is impacted in particular by the formation of dust, whereby the lung of affected persons can be affected.

There is furthermore a need for improving the methods and devices in the mining industry, in particular in response to the processing of ore material, in such a manner that the energy consumption is lowered and damages to the environment are minimized.

### PRIOR ART

Conventionally, the ores are dressed in four steps to date. Several crushers connected in series grind the conveyed ore to a certain particle size, which are then comminuted further by means of wet mechanical methods in mills, mostly ball mills. The created, pumpable suspension is classified or divided, respectively, into different grain classes. The flotation, a physical-chemical process, in which the ore-containing metal in the water is transported to the water surface by adhesive gas bubbles and is siphoned at that location, forms the last step for the dressing of the ore rock. The ore concentrate is created as end product.

In the mining industry, these large comminuting machines form the precursor for the ore dressing. Depending on country, region, yield and size of the mine, some crusher types, which operate in dry mode, and a ball mill connected downstream, including the conveying and screening plants, form the chain of the ore comminution. Size of the plant, energy and logistics effort for the stoneware as well as the dust pollution of the environment are enormous in the case of the common devices.

The comminution principle for example of a jaw crusher operates only with mechanically produced pressure. For the most part, the comminution of the material to be crushed takes place in the wedge-shaped shaft between fixed and an eccentrically moved crusher jaw. In the motion sequence, the stoneware is crushed until the material is smaller than the adjusted crushing gap.

In a ball mill, the process further continues as follows: In ball mills, the ore stone, which is pre-comminuted for the most part, together with iron balls grinds in a drum, which is rotated. The material to be ground is thereby “squashed” by the balls, which manifests itself in a particle comminution, including a wear of the grinding balls, which also contaminate the comminuted ore with the iron from the iron balls.

Ball mills have been known for a long time for comminuting ore, wherein the ore, together with iron balls, is rotated until the desired fineness is reached in the ball mill. Such a known ball mill is already known from DE 40 02 29, wherein the grinding cylinder includes balls, flint or the like for grinding the ore.

In the case of such known ball mills, the grinding cylinder, however, must be designed in a particularly robust manner, in order o be able to withstand the impact of the balls on the cylinder wall without being damaged, whereby the weight of the grinding cylinders increases greatly. As a result of this, the operating costs and the energy expenditure in the case of such balls mills are high. There is also a large wear of the rotating grinding cylinders caused by the balls hitting the grinding cylinder, so that the iron balls as well as the grinding cylinder must be replaced after a relatively short period of time. These iron balls cost approximately US$ 800/ton, depending on the size and procurement, and are used up in a very short time because of the wear, wherein this wear has the result that the grinding material is contaminated by the iron and that the subsequent flotation or the floatation process, respectively, is more extensive. In the case of ball mills, it is furthermore necessary for the ore to be ground by a separate comminuting device and subsequently by one or a plurality of ball mills connected one after the other, in order to comminute the ore in the desired manner, wherein an effective pulverization of the ore material is hardly possible.

In addition, such ball mills are not suitable to comminute or to pulverize, respectively, ore material together with slag or slag by itself, because slag, which is created as waste product in particular in response to the further processing of ore, is very brittle and has a hard structure.

Publication WO 2011/038914 A1 from the same inventor further discloses an already very good device of compact design for comminuting ore. Depending on the type of ore, ore size, etc., there is nonetheless a risk of an overloading of the device, whereby an accumulation can take place in the mill according to WO 2011/038914 A1 depending on the ore to be comminuted in response to the feeding or that the throughput is reduced in an undesirable manner, respectively.

### DESCRIPTION OF THE INVENTION

It is thus the object of the invention at hand to provide a method as well as a device for comminuting ore material and/or in particular of slag, which is to have a high degree of efficiency and which is to prevent an accumulation in response to the feeding of the ore to be comminuted or a throughput reduction, respectively.

With regard to the device, this object is solved according to the features of claim 1 and with regard to the device, it is solved according to the features of claim 9.

The invention is based on the idea of providing a method and a device for comminuting ore material, wherein the device according to the invention comprises an ore feeding unit for feeding ore to be comminuted to a first pulverizer. The first pulverizer is composed of at least two comminuting elements, which can be moved relative to one another and which, together, form at least one comminuting space for the ore to be comminuted such that, by a relative movement in the form of a rotation about the rotational axis of at least one of the two comminuting elements, the ore to be comminuted is at least partially pulverized in that provision is made on at least one of the comminuting elements for one or a plurality of accelerating elements, in particular protrusions, which are in particular arranged on the end face of one of the two comminuting elements and which accelerate and comminute the ore to be comminuted by the rotation of one of the two comminuting elements, and wherein provision is made between the two comminuting elements and/or in at least one of the two comminuting elements for an intermediate space, through which the pulverized ore is transported from the center of rotation toward the outside and away from the two comminuting elements during the rotation. According to the invention, at least one of the two comminuting elements is operatively connected to a hydraulic spring pressure unit, wherein the hydraulic spring pressure unit is designed in such a manner that it supports the corresponding comminuting element, to which it is operatively connected, in a variable and resilient manner in the direction of the other comminuting element, depending on an adjustable hydraulic spring pressure control unit.

This solution is advantageous, because the comminuting element can be displaced and controlled hydraulically due to the variable support of the comminuting element. When forces appear, which appear in response to the pulverization of the ore and which can lead to an overloading of the device, the comminuting element can thus be adjusted by means of the hydraulic spring pressure control unit, whereby an unburdening of the device is effected directly or the appearing forces are reduced, respectively, and an accumulation in response to the feeding of the ore to be comminuted or a throughput reduction, respectively, can be avoided.

In response to a pulverization of the ore in the first pulverizer, a pressure is initially applied to the clumps of ore, which have only been comminuted slightly or not at all. The pressure application is effected by a ramp area, which is designed in a spiral manner and which is formed on one or both comminuting elements. Due to the spiral shape, a conveying effect is created, by means of which the ore located between the comminuting elements, in particular between the ramp area of a comminuting element and a corresponding area of the other comminuting element, is compacted or increasing pressure is applied thereto, respectively, in response to a rotation of a comminuting element. On principle, the pressure applied to the clumps of ore has the effect that the clumps of ore disintegrate into very small parts and thus yield to the pressure. When clumps of ore are present, which do not disintegrate, it is possible that there is a danger that the generated pressure increases further, whereby the burdening of the device components, in particular of the comminuting elements, the drive shaft, the bearings, etc., also increases strongly and can even reach a level, from which damages to individual or a plurality of these components are possible. Due to the use of the hydraulic spring pressure unit according to the invention, an overloading of the components during operation of the first pulverizer can be prevented. This is so, because the hydraulic spring pressure unit deflects, when the burden becomes too large or exceeds a certain, in particular adjusted level, respectively. Due to the deflection of the hydraulic spring pressure unit, a comminuting element is displaced, whereby the comminuting elements are spaced apart from one another. After or in response to a pressure drop, respectively, between the comminuting elements, the deflected hydraulic spring pressure unit causes a return of the comminuting element into the initial position. Due to the displacement of the comminuting element, the gap between the comminuting elements was enlarged, whereby larger ore particles or clumps of ore, respectively, were able to escape from the first pulverizer. As a result of this, a blocking of the micro impact effect is avoided, so that an accumulation in response to the feeding of the ore to be comminuted or a throughput reduction, respectively, can be avoided.

All of the ore particles or clumps of ore, respectively, which escaped from the first pulverizer, are fed to a separation unit, by means of which a separation of the particles, which have already been comminuted sufficiently, and of the particles, which have not yet been comminuted sufficiently, or of the clumps of ore, respectively, is effected. The ore particles or clumps of ore, respectively, which have not yet been comminuted sufficiently, are then once again fed to the first pulverizer or to a second pulverizer.

It is furthermore also possible that ore particles or clumps of ore, respectively, can be present in the area of comminution protrusions of the comminuting elements and do not disintegrate as a result of the pressure acting thereon. Due to the fact that the comminution protrusions of the comminuting elements are arranged radially spaced apart from the center of the comminution protrusions, ore particles or clumps of ore, respectively, in this area effect the creation of high torques, which can lead to damages to the first pulverizer, in particular of one or both comminuting elements, the drive shaft, etc. The arrangement according to the invention of the hydraulic spring pressure unit, which can optionally be adjusted by means of the hydraulic spring pressure control unit, preferably also makes it possible in this case that a comminuting element, in particular the comminuting element, which is coupled to the shaft, is deflected.

Further advantageous embodiments of the device according to the invention and of the method according to the invention follow from the subclaims and/or from the description below.

According to a preferred embodiment of the invention at hand, at least one of the comminuting elements is arranged on a shaft for driving the comminuting element, wherein the hydraulic spring pressure unit is directly coupled to the shaft or the comminuting element and is pretensioned by said shaft and wherein the shaft and the comminuting element arranged thereon can be displaced against the adjustable spring force of the hydraulic spring pressure unit. This embodiment is advantageous, because in particular a protection of the comminuting elements and of the shaft, which is connected to a comminuting element, is effected through this.

According to a further preferred embodiment, a displacement of the shaft and of the comminuting element takes place as a function of the pretensioning of the hydraulic spring pressure unit, wherein the hydraulic spring pressure unit deflects during the operation of the first pulverizer as a result of a deflection force, which is generated between the two comminuting elements and which is directed against a contact pressure resulting from the spring force, when the deflection force exceeds the contact pressure. This embodiment is advantageous, because the spring force preferably serves as significant parameter for the change in position of the shaft and/or of the comminuting element. The spring force can preferably be changed arbitrarily, whereby adjustments or configurations, respectively, which are optimized for different operating and/or basic conditions, can be provided.

According to a further preferred embodiment of the invention at hand, the spring unit comprises that the hydraulic spring pressure unit adjusts the spring force of the hydraulic spring pressure unit within a range of between 100 ms and 1 ms, preferably within a range of between 20 ms and 2 ms, further preferably within a range of between 10 ms and 3 ms and particularly preferably within a range of between 7 ms and 3 ms by means of the adjustable hydraulic spring pressure control unit so as to be variable in the amplitude, in particular in an oscillating manner.

The hydraulic spring pressure unit can further have a plurality of hydraulic suspension means, wherein the individual suspension means are arranged in such a manner that they push the comminuting element, which is coupled to the shaft, in the direction of the other comminuting element. This embodiment is advantageous, because the different suspension means can be designed identically or differently, whereby, in turn, the desired total spring force can be adjusted in a highly accurate manner.

According to a further preferred embodiment of the invention at hand, the shaft is supported in a housing of the device by means of ball bearings and is coupled to a drive unit for rotating the shaft and the comminuting element arranged thereon. The support by means of ball bearings is advantageous, because ball bearings can absorb high forces and can be adjusted very well. This embodiment is also advantageous, because the ball bearings are preferably arranged in the housing of the device according to the invention and are thus protected against environmental influences.

According to a further preferred embodiment of the invention at hand, the hydraulic spring pressure unit is arranged in an end area of the shaft or is coupled to the shaft, respectively, wherein the end area is axially spaced apart from a second end area of the shaft, on which the comminuting element is arranged. Preferably, the ball bearings for supporting the shaft are arranged between the end areas of the shaft. The ball bearings for supporting the shaft are preferably arranged between the end areas of the shaft. Provision is furthermore preferably also made in the area of the end, in which the hydraulic spring pressure unit is provided, for a drive means or a coupling, respectively, comprising a drive means. This embodiment is advantageous, because the hydraulic spring pressure unit is preferably spaced apart from the comminuting elements as far as possible, so as not to experience any damages or functional impairment, if possible, caused by the pulverized ore.

According to a further preferred embodiment of the invention at hand, a comminuting element is arranged on a housing cover, which at least temporarily closes a housing of the device in the direction of extension of the rotational axis, wherein the housing cover can be moved with respect to the device and wherein the fixedly arranged comminuting element is pressed against the other comminuting element by means of the hydraulic spring pressure unit, which connects the housing cover to the device.

The comminuting element is in particular arranged on a housing cover, which at least temporarily closes a housing of the device in the direction of extension of the rotational axis, wherein the housing cover can be moved with respect to the device and wherein the fixedly arranged comminuting element is pressed against the other comminuting element by means of an opening device, which connects the housing cover to the device.

The opening device is preferably embodied as hydraulic suspension means and is particularly preferably formed by means of a hydraulic unit, which also makes it possible to move the housing cover for opening and closing the housing, e.g. for maintenance operations. It is also possible that the comminuting element arranged on the housing cover is supported or pretensioned, respectively, via a spring unit, and that the comminuting means arranged on the shaft is supported or pretensioned, respectively, via a further spring unit.

According to a further preferred embodiment, the spring rate of the hydraulic spring pressure unit, the displacement path of the comminuting element and/or the spring travel of the hydraulic spring pressure unit can be changed, in particular adjusted.

It is furthermore possible that the displacement path of the comminuting element, which is operatively connected to the hydraulic spring pressure unit is less than 5 cm and preferably less than 3.5 cm and particularly preferably is less than 1 cm and in particular preferably is less than 0.5 cm and further particularly preferably is less than 0.1 cm during the operation of the first pulverizer. It is further possible that the contact pressure generated by the spring unit is at least 1000 N, preferably at least 2000 N and particularly preferably at least 10000 N.

Further advantages, goals and characteristics of the invention at hand will be explained by means of the following description of the attached drawings, in which devices according to the invention for comminuting ore are illustrated in an exemplary manner. Components of the devices according to the invention, which correspond at least substantially in the figures with regard to their function, can hereby be identified with identical reference numerals, wherein these components do not need to be numbered or explained in all figures.

The invention will be described below in a purely exemplary manner by means of the enclosed figures.

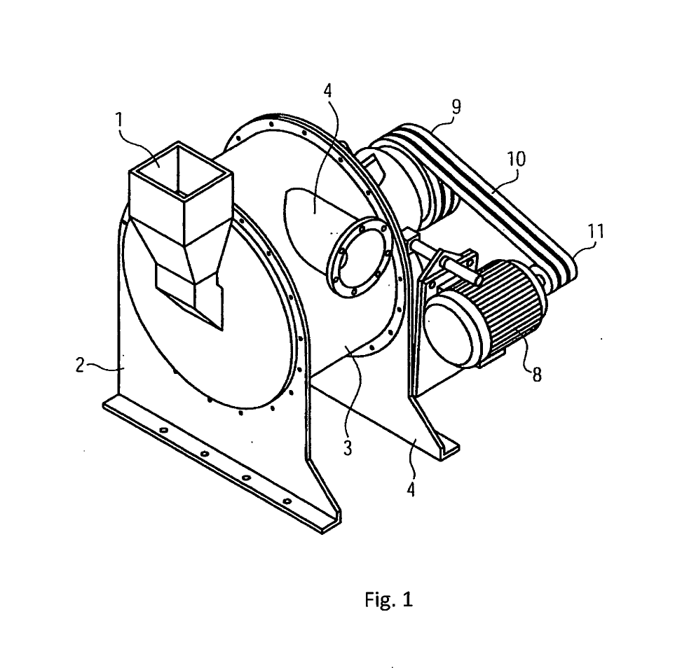

FIG. 1 shows a part of the device according to the invention in perspective view;

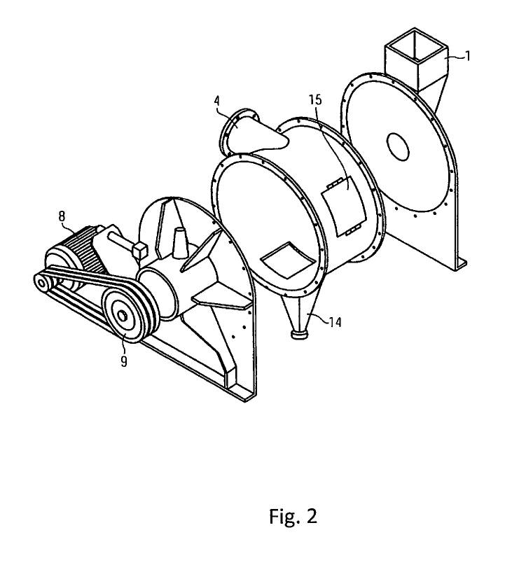

FIG. 2 shows a part of the device according to the invention of FIG. 1 in an extended illustration;

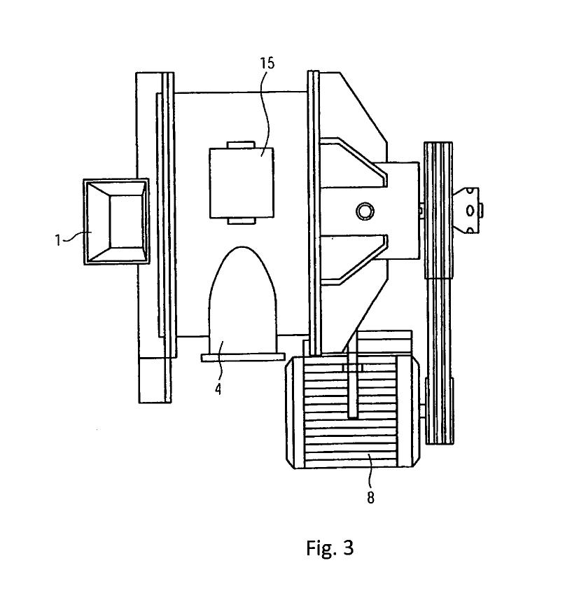

FIG. 3 shows a part of the device according to the invention of FIG. 1 as top view;

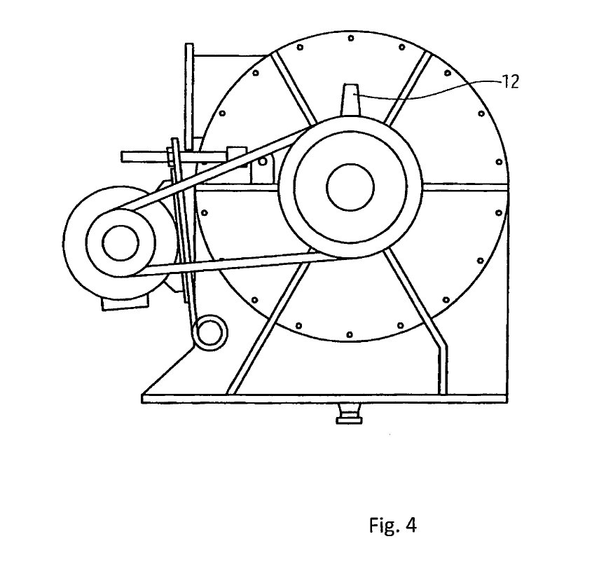

FIG. 4 shows a lateral view of the part of the device according to the invention of FIG. 1;

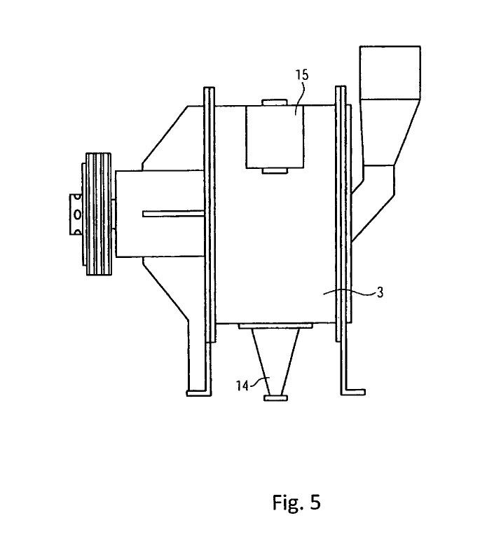

FIG. 5 shows a part of the device according to the invention in a side view of FIG. 1;

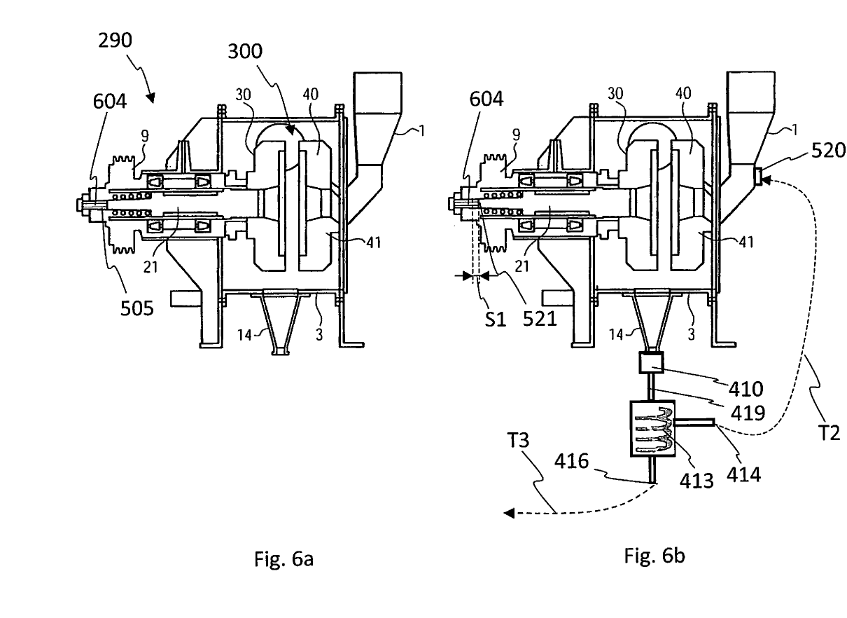

FIG. 6a shows a part of the device according to the invention of FIG. 1, partially in cross section;

FIG. 6b shows the illustration of FIG. 6a, supplemented by a separator and corresponding components;

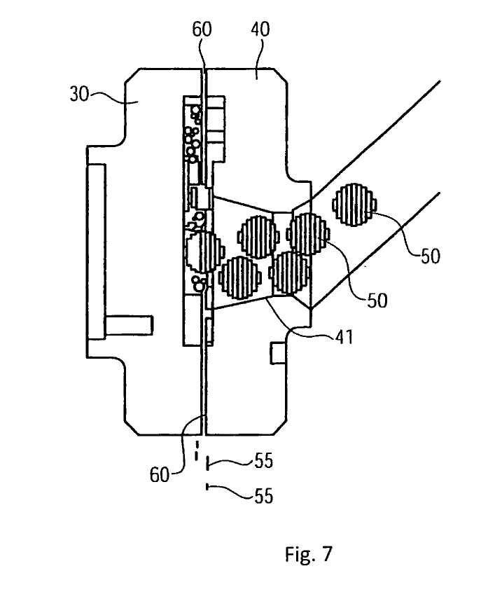

FIG. 7 shows, schematically, the two comminuting elements of FIG. 6 in cross section;

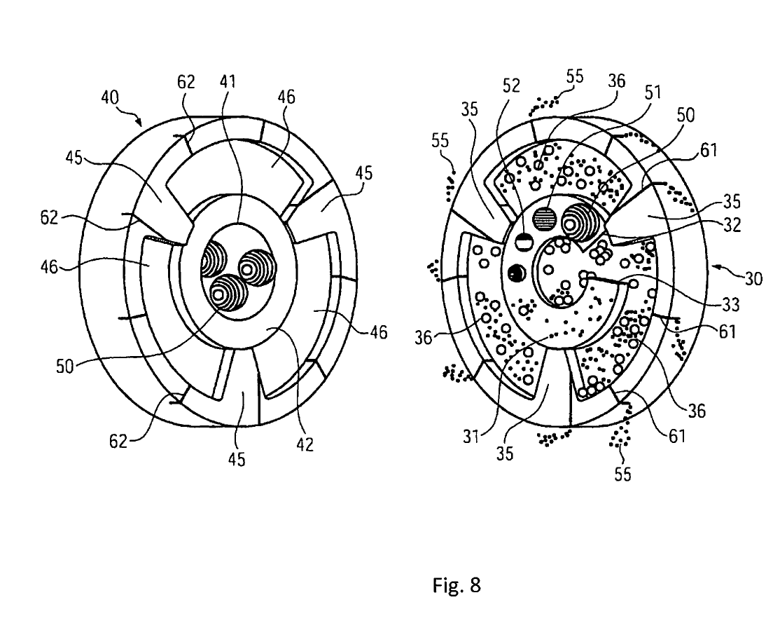

FIG. 8 shows the two comminuting elements of FIG. 7 in an opened up position;

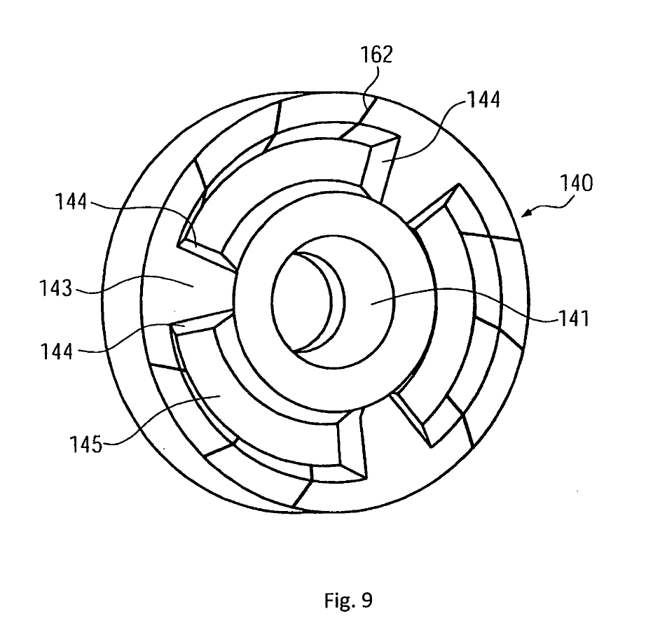

FIG. 9 shows a comminuting element analogously to FIG. 8, illustrated schematically;

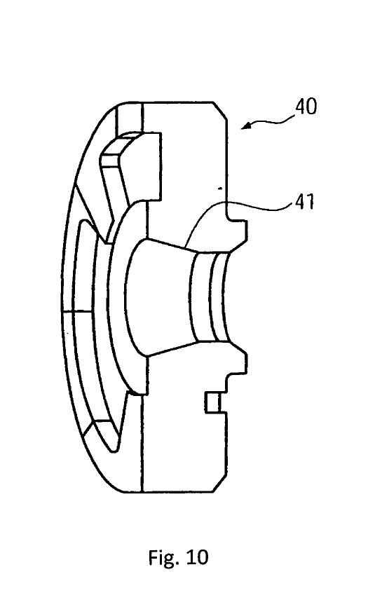

FIG. 10 shows the comminuting element of FIG. 8, partially in cross section;

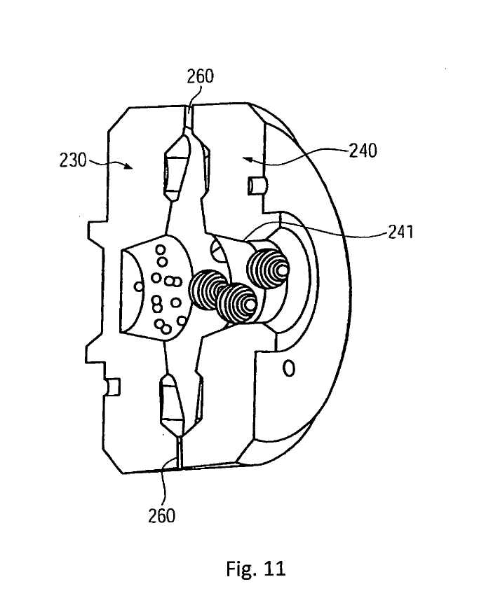

FIG. 11 shows further embodiments of the comminuting elements for the part of the device according to the invention according to FIG. 6a;

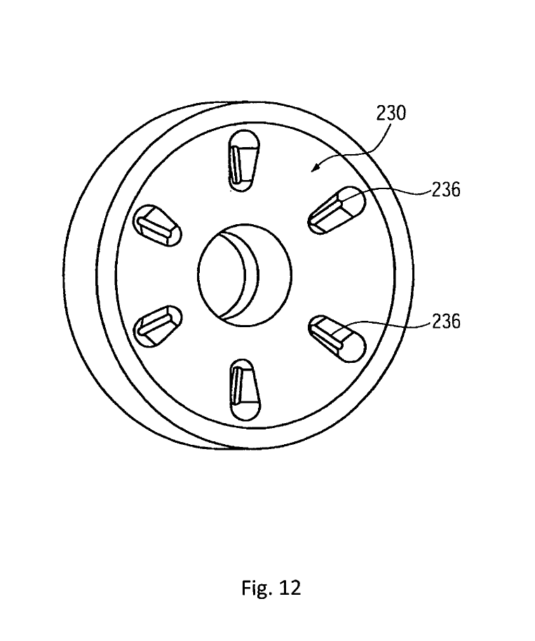

FIG. 12 shows, schematically, a comminuting element of FIG. 11;

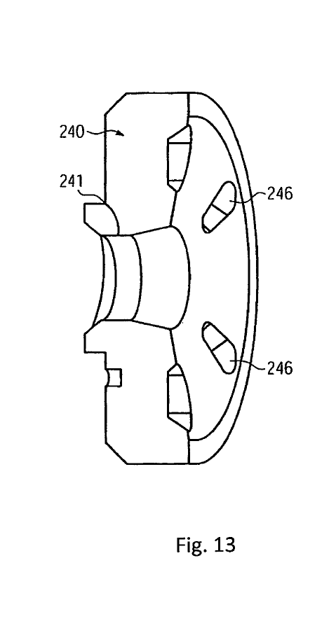

FIG. 13 shows the other comminuting element of FIG. 1, partially in cross section;

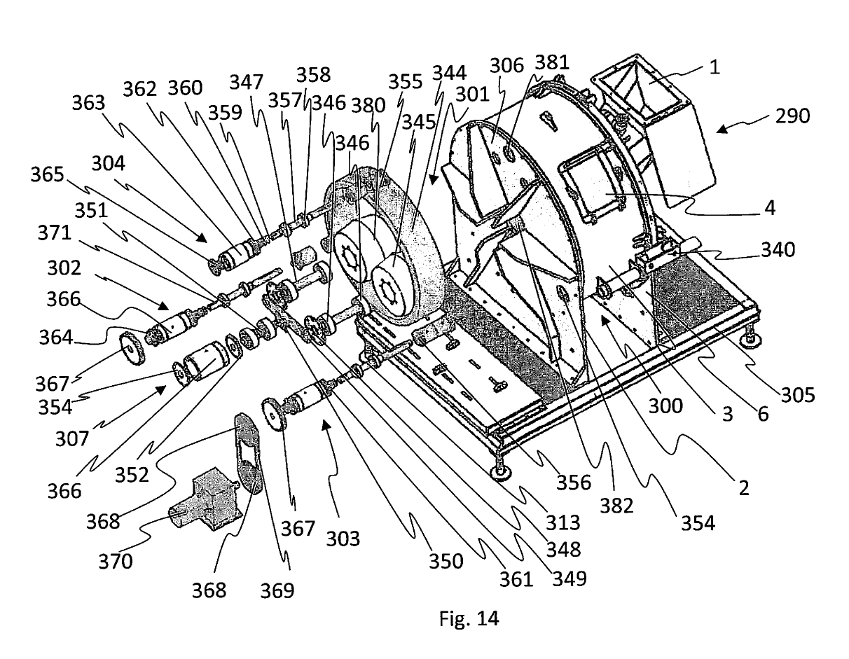

FIG. 14 shows a perspective view of the device according to the invention in an exploded illustration;

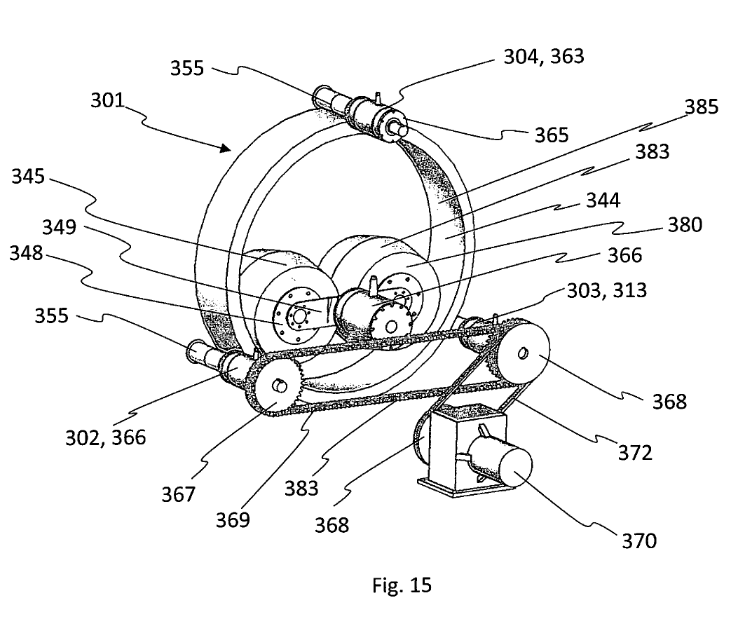

FIG. 15 shows a perspective view of a preferred embodiment of a second pulverizer of the device according to the invention,

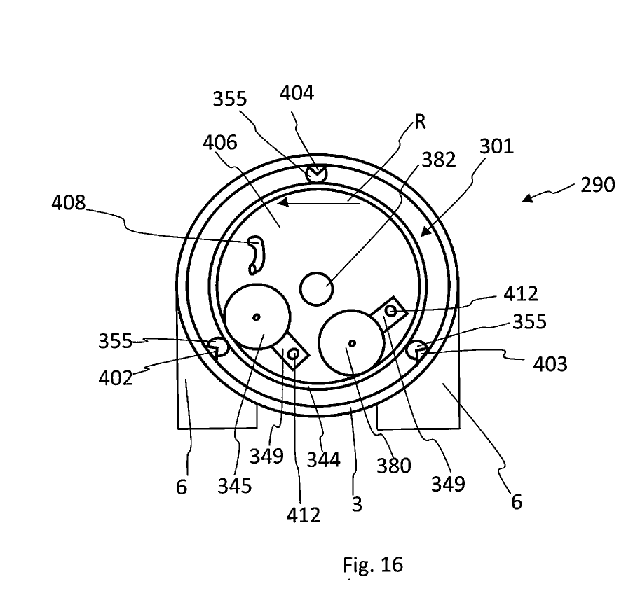

FIG. 16 shows a schematic illustration of the second pulverizer,

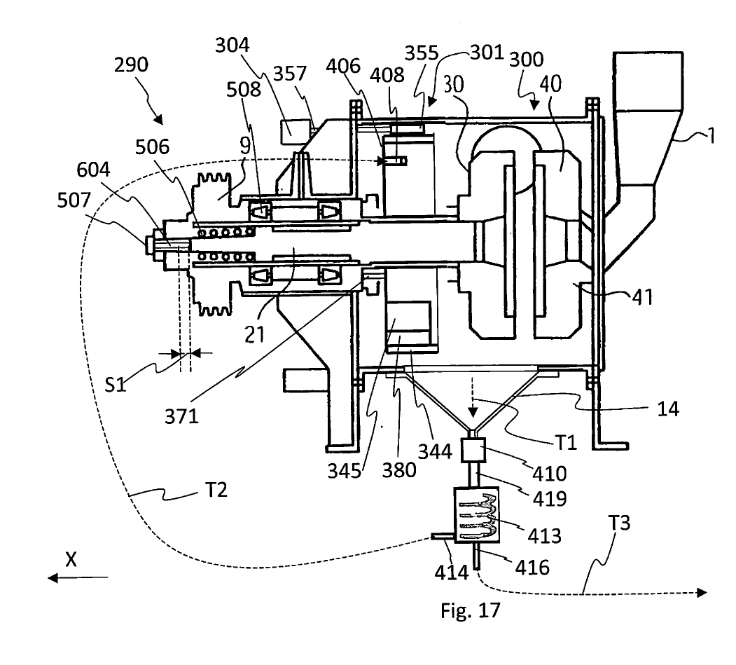

FIG. 17 shows a schematic sectional illustration of the ore comminuting device according to the invention;

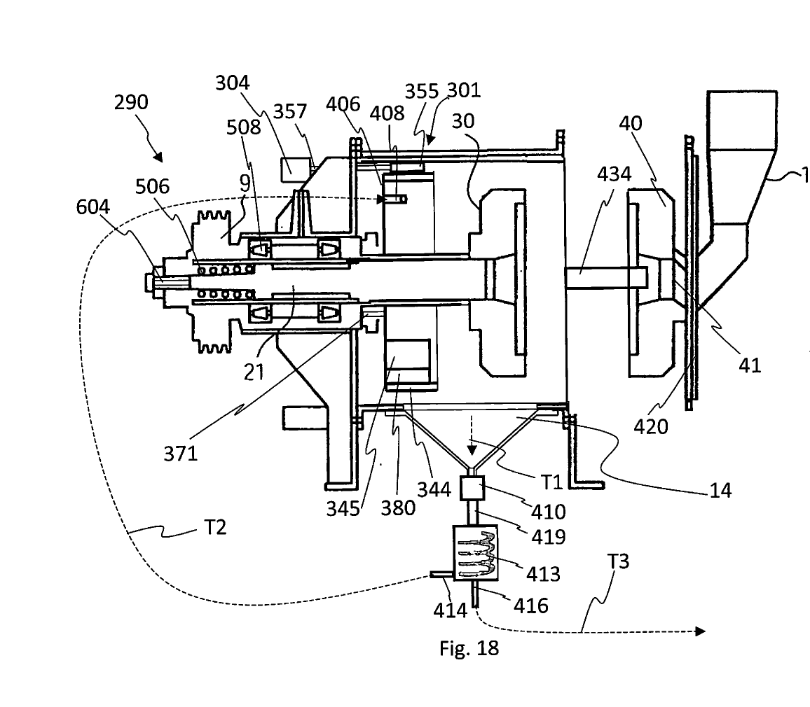

FIG. 18 shows the illustration of FIG. 17 in an opened configuration;

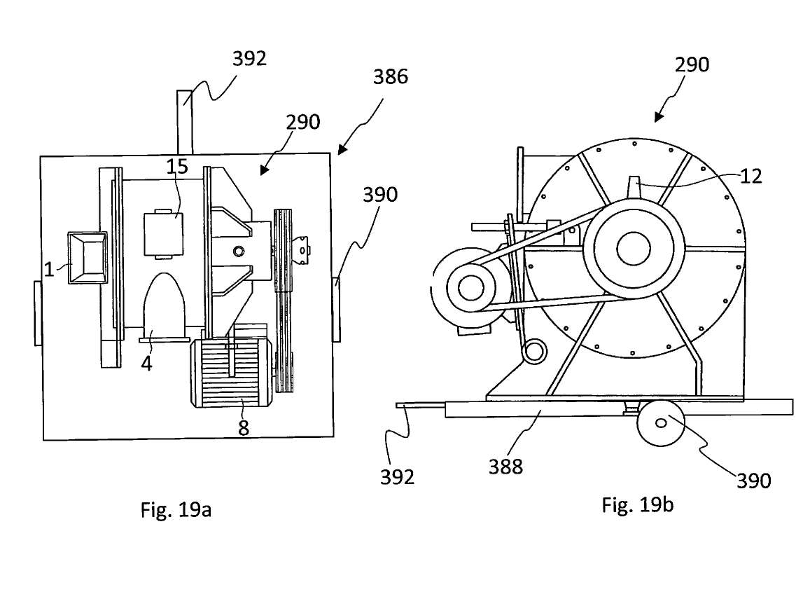

FIG. 19a shows a schematic illustration of a device according to the invention on a transport unit in a top view;

FIG. 19b shows a schematic illustration of a device according to the invention on a transport unit in a side view;

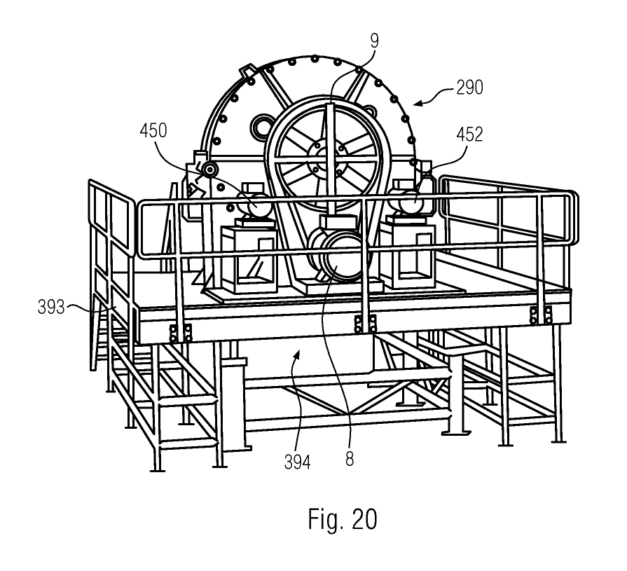

FIG. 20 shows a device according to the invention on a platform;

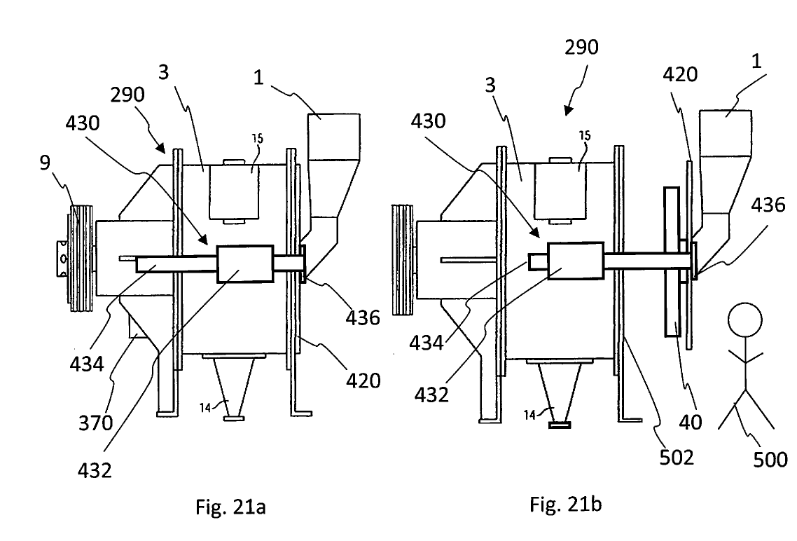

FIG. 21a shows a device according to the invention in a closed state and comprising a closing unit; and

FIG. 21b shows a device according to the invention in an open state.

According to FIG. 1, the device according to the invention is illustrated, wherein the ore to be comminuted or the slag to be comminuted, respectively, is introduced into a funnel or feed funnel 1, respectively, which represent the ore feeding unit. In the alternative, a screw conveyor can also be provided instead of a funnel, which feeds the ore to be comminuted into the first pulverizer under pressure. The ore is fed through the funnel 1 to the cylindrical housing 3, which is supported on a base 2 and a base 6. The ore to be comminuted is pulverized in this housing 3. A motor 8 ensures this via a drive roller 11 and a belt 10 as well as a belt pulley 9 for the torque transmission from the motor 8 to the first pulverizer.

As can in particular be gathered from FIG. 2, a suction opening 4 is optionally possible, through which the pulverized ore can be extracted by means of a low pressure. In the alternative and in particular in the normal case, provision is made in the lower area of the housing 3 for an outlet funnel 14, which generally forms the first outlet unit. The pulverized ore is discharged from the device according to the invention through this outlet funnel 14 with the help of the force of gravity or also by means of extraction.

A control flap 15 can be provided on the housing 3, so as to gain access to the interior of the housing, if applicable. However, this is not necessary for the function of the device according to the invention. As can in particular be gathered from FIG. 3, the control flap 15 as well as the feed funnel 1 is arranged in the upper area of the device according to the invention. The ore can further be fed in a continuous manner to the first pulverizer through the feed funnel or can also be fed in a non-continuous manner to the first pulverizer, if ore or slag is fed only sporadically to the device according to the invention.

FIG. 4 or FIG. 5, respectively, in each case show a side view of the device according to the invention, from which it can be seen that the outlet funnel 14 is provided in the lower area of the cylindrical housing 3.

In particular the function and the setup of the first pulverizer can be gathered from FIG. 6a. As already described, the belt pulley 9 is driven by the motor 8 and transfers this torque via a shaft 21 to a comminuting element 30, which thus rotates. In the simplest form, the comminuting element 30 is set up as rotating rotary element 30 comprising a disk-shaped design, which, together with a stationary fixed element 40, forms the first pulverizer 300. As can be seen from FIG. 6, the ore to be comminuted is fed into the housing 3 via the inlet funnel 1 in that provision is substantially made in the center of the fixed element for a feed opening 41. The ore material fed through the feed opening 41 is now pulverized between the fixed element 40 and the rotating rotary element 30 and is expelled or removed, respectively, in pulverized form radially toward the outside between the two comminuting elements 30, 40 and is collected within the housing 3 in pulverized form and is then discharged by the outlet funnel 14.

When looking at the course of the material or of the rocks, respectively, in the device according to the invention in detail, the material or the rocks, respectively, initially reaches into the machine via a feed funnel. The material enters into the intermediate space via passage opening in the middle of the stationary disk jaw or of the stationary comminuting element 40, respectively, wherein the driven disk jaw or the comminuting element 30, respectively, ensures the acceleration of the material or of the stoneware, respectively. Driver elements, which provide the fed ore rocks with a radial speed, are preferably integrated into the geometry of the disk jaws 30, 40. The rocks collide with one another with the absorbed acceleration energy and this leads to the pulverization of the grinding material in a highly efficient manner.

This micro impact is based on the fact that the material accelerates due to the relative movement of the comminuting elements 30, 40 or of the jaws, respectively, and the comminution occurs in very quick time intervals due to the tightness of the intermediate space. The driver elements on the disk jaws 30, 40 ensure the high speeds in radial as well as in axial direction, so that, as a result, the powder, which is created, is pushed outwards out of the intermediate space and leaves the device 290 again as powder or as powder for further processing, respectively, via outlet funnel 14. The level of the pulverization—in other words the grain size—in particular determines the distance of the two disk jaws or of the two comminuting elements 30, 40, respectively. The smaller the distance, the finer the grain size. By adding water, the operating process in the mill is shortened once again. The operating personnel thus has a plurality of adjusting parameters for required grain sizes—without any dust pollution.

The device according to the invention illustrated in FIG. 6a is shown in a modified manner in FIG. 6b. According to this illustration, a pump unit 410, to which, in turn, a separation unit 413 is connected, is connected to the outlet funnel 14. Particularly preferably, the separation unit 413 is designed as centrifuge. The ore fed to the pump unit 410 via the outlet funnel 14 is preferably accelerated by means of the pump unit 410 and/or pressure is applied thereto and is introduced into the separation unit 413 via a line section 419, in particular a tube or a hose. It is also possible, however, that the pump unit 410 is directly or indirectly connected to the separation unit 413. Ore, which is to be fed once again to the first pulverizer, in particular to the comminuting elements 30, 40, is discharged via the first outlet 414. The feeding of the ore discharged via the first outlet 414 preferably takes place according to the transport path T2, i.e., the ore, which is to be further comminuted, is preferably fed to the feed funnel 1. Particularly preferably, the housing 3, the first pulverizer 300 and/or the feed funnel 1 has a feed connection 520, via which free-flowing substances can be fed to the first pulverizer 300. In particular the ore, which is supplied via T2, is hereby considered to be a free-flowing substance. The feed connection 520 can furthermore have a plurality of coupling locations for coupling one or a plurality of further line elements. It is thus also possible that a line or a line element, respectively, for feeding a liquid, in particular water or a liquid having water, is coupled to the device 290 according to the invention via the feed connection 520. The separation unit 41 preferably has a second outlet 416, from which the ore, which has already been sufficiently comminuted, is discharged. The sufficiently comminuted ore or the ore, respectively, which is to not/does not need to be fed to the first pulverizer 300, i.e. the comminuting elements 30, 40, is preferably guided directly to a further processing unit, in particular a second pulverizer (see FIG. 17) or to a flotation unit according to the transport path T3.

A hydraulic spring pressure unit 604 is furthermore illustrated schematically in FIGS. 6a and 6b in the area of an axial end 521 of the shaft 21. The hydraulic spring pressure unit 604 can be formed as hydraulic suspension means, e.g., and is preferably arranged between the belt pulley 9 and the shaft 21. It is also possible, however, that the hydraulic spring pressure unit 604 can also be formed or provided, respectively, at other positions in the area of the shaft 21. Reference numeral S1 identifies a displacement path, which the shaft 21 can traverse or between which the shaft 21 is variably supported when the shaft 21 is displaced in its axial direction by means of the hydraulic spring pressure unit.

The hydraulic spring pressure unit 604 can also be adjustable by means of the non-illustrated hydraulic spring pressure unit in such a variable manner that the particle size of the ore to be comminuted can be adjusted as a function of a freely selectable control variable. For this purpose, the hydraulic spring pressure unit can also perform an oscillating movement, which is controlled by the hydraulic spring pressure control unit, on the comminuting element, which is variably supported. The oscillating movement can be controlled hydraulically in such a manner that the amplitude changes in particular in a period of between 4 milliseconds and 7 milliseconds from a maximum value to a next maximum value, but larger time intervals of up to 100 milliseconds can also be provided. This oscillating movement also supports the avoidance of an accumulation in response to the feeding of the material to be comminuted into the comminuting space between the movable comminuting elements, wherein the particle size is increased by means of the oscillating movement, if applicable. The corresponding travelling distance between the initial position of the variably adjustable comminuting element by means of the hydraulic spring pressure unit 604 can thereby be a few tenths of a millimeter, in particular 0.5 mm, but it can also vary and can have ranges of up to 1 mm, 2 mm, 5 mm, 1 cm, 2 cm and 5 cm.

As a whole, an accumulation in response to the feeding of the ore to be comminuted is avoided in the device according to the invention, in particular in the comminuting space, by means of the use of the hydraulic spring pressure unit 604 according to the invention, which is variably controlled by means of the hydraulic spring pressure control unit, and the throughput through the device according to the invention can also be increased through this so as to reach a higher efficiency of the ore comminution. The hydraulic spring pressure unit 604 is supported on a fixed support unit 507 in a stationary manner. This means that the shaft 21 can be variably positioned within the travelling path S1 and until the complete attachment of the two comminuting elements 30, 40.

In response to a pulverization of the ore in the first pulverizer 300, a pressure is initially applied to the clumps of ore, which have only been comminuted slightly or not at all. The pressure application is effected by means of a ramp area 31, which is designed in a spiral manner and which is embodied on one or both comminuting elements 30, 40. Due to the spiral shape, a conveying effect is created, by means of which the ore located between the comminuting elements 30, 40, in particular between the ramp area 31 of a comminuting element 30 and a corresponding area 42 of the other comminuting element 40, is compacted or increasing pressure is applied thereto, respectively, in response to a rotation of a comminuting element 30. On principle, the pressure applied to the clumps of ore has the effect that the clumps of ore disintegrate into very small parts and thus yield to the pressure. When clumps of ore are present, which do not disintegrate, there is a risk that the generated pressure increases further, whereby the burdening of the device components, in particular of the comminuting elements 30, 40, the drive shaft 21, the bearings 506, 508, etc., also increases strongly and can even reach a level, from which damages to individual or a plurality of these components are possible. Due to the use of the hydraulic spring pressure unit 604 according to the invention, an overloading of the components during operation of the first pulverizer 300 can be prevented. This is so, because the hydraulic spring pressure unit 604 deflects, when the burden becomes too large or exceeds a certain, in particular an adjusted level, respectively. Due to the deflection of the hydraulic spring pressure unit 604, a comminuting element 30 is displaced, whereby the comminuting elements 30, 40 are spaced apart from one another. After or in response to a pressure drop, respectively, between the comminuting elements 30, 40, the deflected hydraulic spring pressure unit 604 causes a return of the comminuting element 30 into the initial position. Due to the displacement of the comminuting element 30, the gap between the comminuting elements 30, 40 was enlarged, whereby larger ore particles or clumps of ore, respectively, were able to escape from the first pulverizer 300. All of the ore particles or clumps of ore, respectively, which escaped from the first pulverizer 300, are fed to a separation unit 413, by means of which a separation of the particles, which have already been sufficiently comminuted, and of the particles or clumps of ore, respectively, which have not yet been sufficiently comminuted, is effected. The ore particles or clumps of ore, respectively, which have not yet been sufficiently comminuted, are then once again fed to the first pulverizer 300 or to a second pulverizer 301.

It is furthermore also possible that ore particles or clumps of ore, respectively, can be found in the area of comminution protrusions 35, 45 of the comminuting elements 30, 40 and do not disintegrate as a result of the pressure acting thereon. Due to the fact that the comminution protrusions 35, 45 of the comminuting elements 30, 40 are arranged radially spaced apart from the center of the comminution protrusion 35, 45, ore particles or clumps of ore, respectively, in this area effect the creation of high torques, which can lead to damages to the first pulverizer 300, in particular of one or both comminuting elements 30, 40, the drive shaft 21, etc. The arrangement according to the invention of a hydraulic spring pressure unit 604 preferably also makes it possible in this case that a comminuting element 30, 40, in particular the comminuting element 30, which is coupled to the shaft 21, is deflected.

Due to the small space requirement of the comminution space, the type of pulverization according to the invention only takes a short period of time, wherein the pulverized ore is removed toward the outside and away from the two comminuting elements 30, 40 through an intermediate space 60 between the two comminuting elements 30, 40 during the rotation of the rotary element, as is illustrated in an exemplary manner by means of the pulverized ore 55 in FIG. 7. This means that the clumps of ore are pulverized by means of a relative movement in the form of a rotation between the two comminuting elements 30, 40, wherein, according to a further embodiment, two comminuting elements 30, 40 with a different speed as well as the same or opposite direction of rotation, can be used.

The pulverization will be explained in more detail in particular with regard to FIG. 7. Analogous to FIG. 6a, the ore to be comminuted is fed into a comminuting space between the fixed element 40 and the rotary element 30 via the feed opening 41, which is preferably located substantially in the center of the comminuting section 40, which is preferably designed as fixed element. FIG. 7 shows individual clumps of ore 50 in an example manner, which show the ore to be comminuted. After the clumps of ore 50 to be comminuted come into contact with rotary element 30 through the feed opening 41, the rotation of the rotary element 30 ensures that the clumps of ore 30 are accelerated radially outwards an in the direction of rotation of the rotary element 30. For this purpose, the two comminuting elements form a comminuting space, wherein one or a plurality of accelerating elements are arranged at least on the rotary element or the fixed element, so as to ensure an acceleration as well as a corresponding comminution of the fed ore. By rotating the rotary element 30, the ore to be comminuted is pulverized directly by the contact with the rotary element 30 and is thus also pulverized by the contact of ore, which has already been partially comminuted, with one another as well as by contact with the fixed element 40 in the comminuting space.

FIG. 8 shows the two comminuting elements of FIG. 7 in the opened up state, together with ore 50 to be comminuted, which is arranged in an exemplary manner, and pulverized ore 55. The ore 50 to be comminuted is fed via the feed opening 41 through the fixed element 40 into the comminuting space between the two comminuting elements, as already explained. Optionally, the rotary element 30 has a ramp area 31, which has a rising gradient from the ramp beginning 32 to the ramp end 33 and which can be a part of the comminuting space. By means of the rotation of the rotary element 30, the ore 50 to be comminuted is already comminuted on the basis of the rising ramp area 31, as is illustrated schematically by means of the spherical ore particles 51 and 52, which become smaller. The ramp area 31 thereby cooperates with an annular area 42 of the fixed element 40. The ore is subsequently accelerated and pulverized by protrusions 35, which act as accelerating elements, on the basis of the rotation of the rotary element 30 and which are arranged at regular intervals in circumferential direction of the rotary element 30 in FIG. 8. The fixed element 40 can also have protrusions 45, which are arranged analogously to the protrusions 35 of the rotary element 30. Provision is made between the protrusions 35 of the rotary element for corresponding recesses 36 on the end face of the rotary element 30 as part of the comminuting space. The protrusions 35 in particular have a predetermined angle in the transition to the recesses 36 in order to accelerate the ore to be comminuted in radial direction according to the rotation as well as in axial direction of the rotational axis of the rotary element. The ore to be comminuted is thus accelerated into the center of the comminuting space and meets other accelerated ore elements at that location, so that a fictitious pulverization results by means of the micro impact.

Optionally, the fixed element 30 has corresponding recesses 46 between the protrusions 45 of the fixed element 40. After the ore between the fixed element 40 and the rotary element 30 has been pulverized in particular by means of the acceleration by means of the protrusions 35, the ramp area 31 and the protrusions 45 of the fixed element based on the rotation, the pulverized ore 45 reaches into the intermediate space 60 between the two comminuting elements 30, 40. As already described, the intermediate space 60 is formed by the variable distance between the two comminuting elements 30, 40, wherein, in addition to the variable distance in the rotary element 30, provision can be made in the rotary element 30 for outlet recesses 61, which lead away from the rotational axis of the rotary element 30 in a star-shaped manner. Analogously thereto, provision is made in the fixed element 40 for outlet recesses 62 at regular intervals. As illustrated schematically with regard to rotary element 30 in FIG. 8, the pulverized ore 55 is discharged toward the outside through the outlet recesses 61 or 62, respectively. If the distance between the rotary element 30 and the fixed element 40 is virtually not present, i.e. that the two elements substantially adjoin one another, the pulverized ore 55 is substantially discharged toward the outside through the outlet recesses 61 or 62, respectively. The variable distance between the two comminuting elements can in particular be adjusted by means of a hydraulic unit, wherein the fixed element 40 can preferably be variably positioned in axial direction with respect to the rotary element 30, so as to be able to adjusted the pulverization in particular to a different ore material with respect to the size or composition, respectively.

According to a further embodiment, the fixed element 30 or the rotary element 40 or the two comminuting elements, respectively, can be moved away from one another hydraulically in axial direction for repair and assembly operation. As an alternative thereto, the comminuting elements can be spaced apart from one another from the operating position by means of a pivoting movement of one of the two comminuting elements. For example the accelerating elements 35 or other elements, which are subjected to great mechanical stress, of the first pulverizer can thus be processed or replaced. This furthermore makes it possible that elements, which are subjected to great mechanical stresses, within the first pulverizer or for example the accelerating elements or protrusions 35, respectively, can be made of different materials and can be replaced as needed. Wear parts within the comminuting space, such as the protrusions, for example, can thus further also be adapted to different ore material.

With regard to FIG. 6, which illustrates a schematically enlarged distance between the rotary element 30 and the fixed element 40, it can be seen that the ore to be comminuted is centrifuged toward the outside in radial direction by means of the rotation in the case of only a small distance and is caught by the housing 3, before the pulverized ore is discharged from the device 290 according to the invention via the outlet funnel 14, for example only by means of the force of gravity or in addition by means of a suction unit or a pump unit or the like.

FIG. 9 shows a further embodiment of a fixed element 140, which has a feed opening 141 in the center. The fixed element 140 is substantially identical with the fixed element of FIG. 8, wherein the fixed element 140 has outlet recesses 162, which are placed diagonally and through which the pulverized ore is transported toward the outside.

The fixed element 41 shown in FIG. 9 can also be used second rotary element in the illustrated form, which can have a different relative speed as compared to the rotary element 30 illustrated in FIG. 8.

The embodiment of a comminuting element shown in FIG. 9 has an angle range 144, which in each case extends on both sides from the accelerating element 143 to the recess 145. Depending on the rotational direction, these two angle ranges 144, however, can also only be provided on one side of the accelerating element 143 so as to accelerate the ore to be comminuted in radial as well as in axial direction with respect to the rotation of the comminuting element, depending on the rotational direction of the comminuting element. Together with the accelerating elements of the rotary element 30 shown in FIG. 8, a particularly effective pulverization can thus result, in particular if the accelerating elements of the rotary element 30 also have an angle range, which is congruent to the angle ranges 144 of the comminuting element of FIG. 9 or if they are arranged in a substantially mirror-inverted manner relative to one another, respectively.

A cross section of the fixed element 40 of FIG. 8 is illustrated in FIG. 10, wherein the feed opening 41 has a funnel-shaped setup.

According to FIG. 11, a further embodiment of the comminuting elements according to the invention at hand is illustrated.

As an alternative to the comminuting elements according to FIG. 7 to FIG. 10, further embodiments for cooperating comminuting elements are illustrated in FIG. 11 to FIG. 13, which can be arranged within the device according to the invention according to FIG. 6.

A fixed element 240 and a rotating rotary element 230 is illustrated in FIG. 11, wherein the ore 50 to be comminuted is fed into the comminuting space between the fixed element 240 and the rotary element 230 via the feed opening 241. As can further be seen from FIG. 11, the comminuting space between the fixed element 240 and the rotary element 230 is embodied so as to substantially taper conically toward the outside from the rotational axis of the rotary element 230, whereby the pulverization of the ore is accomplished on the one hand. On the other hand, it can be seen from FIG. 12 that the rotary element 230 has recesses 236, which are arranged at a regular interval around the rotational axis of the rotary element. In particular due to the transitions of the recess 236, which are arranged diagonally, these recesses 236 ensure an acceleration and thus a pulverization of the ore based on the rotation, which ensures a relative movement between the rotary element 230 and the fixed element 240.

The fixed element 240 of FIG. 11, which cooperates with the rotary element 230 of FIG. 12, is illustrated in FIG. 13. In the cross section in FIG. 13, the fixed element 240 shows the feed opening 241. Analogously to the rotary element 230, the fixed element 240 has recesses 246 in radial direction around the center of the axis of rotation. In particular the chamfered areas of the recesses 236, 246 of the rotary element 230 and of the fixed element 240 ensure an acceleration and comminution of the ore, which is discharged toward the outside in pulverized form through the intermediate space 260 between the rotary element 230 and the fixed element 240.

According to the invention, a method for comminuting ore material and/or in particular of slag is thus provided, wherein the ore feeding unit 1 is provided for feeding ore to be comminuted to a first pulverizer. The first pulverizer is composed of at least two comminuting elements 30, 40, which can be moved relative to one another and which, together, form a comminuting space for the ore to be comminuted such that, by a relative movement in the form of a rotation of at least one of the two comminuting elements 30, 40, the ore to be comminuted is pulverized in that provision is made on at least one of the comminuting elements 30, 40 for one or a plurality of accelerating elements, in particular protrusions, which are in particular arranged on the end face of one of the two comminuting elements 30, 40 and which accelerate or comminute, respectively, the ore to be comminuted by the rotation of one of the two comminuting elements 30, 40. Provision is made between the two comminuting elements 30, 40 and/or in at least one of the two comminuting elements for an intermediate space 60, through which the pulverized ore is transported from the center of rotation or from the rotational axis of the rotary element, respectively, toward the outside and away from the two comminuting elements 30, 40 during the rotation. The ore pulverized between the two comminuting elements through this is discharged toward the outside through an outlet unit, which is at least functionally connected to the intermediate space 60.

Merely as an option, water can also be fed into the comminuting chamber through a non-illustrated water inlet or by means of feeding water through the ore feeding unit. The water, together with the ore, thereby forms a slag-like connection during and after the pulverization, wherein the water, together with the pulverized ore material, is removed through the outlet unit.

As has already been explained with respect to FIG. 8, the ramp area 31 is in particular advantageous for the comminution of slag, because such a ramp area at the rotary element ensures a pre-comminution of slag based on the rotation of the rotary element, wherein provision is made in the comminuting elements in transport direction downstream from the ramp area for protrusions and/or recesses according to the invention, in order to pulverize the slag, which is particularly brittle and hard.

It is readily apparent to the person of skill in the art that the number of the protrusions on the two comminuting elements can in each case be identical, wherein, however, a different number of accelerating elements can also be provided on the two comminuting elements. According to a non-illustrated embodiment, both comminuting elements can rotate in opposite direction so as to increase the relative movement between the two comminuting elements. However, this leads to a higher structural effort and is to be made only in special cases.

In particular, the shape of the comminuting chamber, which is formed by the two comminuting elements, can be designed in different types, wherein different types of accelerating elements can be arranged in plate-shaped or wedge-shaped or similar form, by means of which the ore to be comminuted is accelerated and thus pulverized between the two comminuting elements.

In addition to the comminution between the two comminuting elements, provision can also be made according to a non-illustrated embodiment for a further comminuting chamber, which is provided independently from the two comminuting elements, but which is integrated in the device according to the invention.

A device according to the invention and a method according to the invention for comminuting ore material and/or in particular of slag is thus described, which comprises an ore feeding unit for feeding ore to be comminuted to a first pulverizer, wherein the first pulverizer is composed of at least two comminuting elements, which can be moved relative to one another and which, together, form at least one comminuting space for the ore to be comminuted such that, by a relative movement in the form of a rotation of at least one of the two comminuting elements, the ore to be comminuted is pulverized in that provision is made on at least one of the comminuting elements for one or a plurality of accelerating elements, in particular protrusions, which are in particular arranged on the end face of at least one of the comminuting elements and which accelerate and comminute the ore to be comminuted by the rotation of one of the two comminuting elements, and wherein provision is made between the two comminuting elements and/or in at least one of the two comminuting elements for an intermediate space, through which the pulverized ore is transported from the center of rotation toward the outside and away from the two comminuting elements during the rotation, and wherein provision is made for an outlet unit, in particular an outlet unit, which is connected to the housing of the device, through which the pulverized ore is discharged.

A perspective exploded illustration of the device 290 according to the invention is illustrated in FIG. 14. It can be gathered from this illustration that, in the area of a first pulverizer 300, the device 290 has a feeding unit 1, in particular a feed funnel 1, by means of which ore to be processed can be guided into the housing 3 to the first pulverizer 300. The housing 3 is preferably positioned by means of two bases 2, 6, which are designed in a plate-like manner, with respect to the ground or are coupled to a frame element 305, respectively which is preferably arranged on the bottom side of the housing 3. The housing 3 of the first pulverizer 300 preferably has an opening 4, in particular a suction opening 4, for extracting ore, which has already been comminuted. An outlet unit 14 is furthermore formed below the housing 3 or in the lower area of the housing 3, respectively, i.e. preferably in the area below the first pulverizer 300 and/or below the second pulverizer 301 (see FIG. 17).

Reference numeral 340 preferably identifies a hydraulic unit (see FIG. 20a/b).

The second pulverizer 301 is formed laterally next to the first pulverizer 300. The first pulverizer 300 and the second pulverizer 301 are arranged on the same frame element 305. Preferably, a housing wall 306 of the housing 3 is coupled to the first pulverizer 300 on the one side and to the second pulverizer 301 on the other side. The housing wall 306 preferably has a plurality of fixing locations 354, 381 for arranging, accommodating and/or fixing a first means 302 for fixing and/or supporting a rotational body, which is preferably formed as grinding ring 344, a second means 303 for fixing and/or supporting the grinding ring 344, and a third means 304 for fixing and/or supporting the grinding ring 344. The grinding ring 344 is preferably movably supported and drivable by means of the movement means 302, 303 and 304. The grinding ring 344 furthermore preferably encloses at least one further rotational body 345 in radial direction and particularly preferably at least one or exactly two rotational bodies 345, 380, which are particularly preferably formed as drum-like bodies. An opening 382 is furthermore preferably formed in the housing wall 306. The first opening 382 particularly preferably serves for the feed-through of the drive shaft, which is provided for driving the comminuting element 30.

The first means 302 and the second means 303 are preferably formed identically and are preferably arranged below a center of the grinding ring 344 in vertical direction. The means 302, 303 can also be identified as axles or movable shafts 371, 313. Preferably, the first means 302 and the second means 303 in each case have a force application element, in particular a drive wheel 367. The drive elements 367 are preferably mechanically coupled to one another and can thus be moved or driven, respectively, simultaneously or synchronously, respectively. A disk element 364, a fixing body 366, a stop element 361, ball bearing and/or one or a plurality of accommodating sleeves 356, by means of which the axles or shafts 371, 313, respectively, can preferably be brought into an operative connection with the grinding ring 344, are preferably connected to the drive wheel 367 in axial direction.

A drive wheel 367 of a means 302, 303 is preferably directly or indirectly connected to a further drive element 368, in particular a gear wheel for transmitting drive forces. Via a continuous element 369, in particular a chain or a belt, the gear wheel 368 is preferably connected to a further drive element, in particular a further gear wheel 368, which is preferably arranged directly on the drive unit, in particular a motor 370. It is also possible, however, that the motor 370 cooperates directly with one of the drive wheels 367 or is arranged thereon, respectively. The third means for fixing and/or transmitting force 304, which can preferably also be identified as upper axle or shaft 357, respectively, is preferably arranged above the center of the grinding ring 344 and is particularly preferably arranged exactly above the center of the grinding ring 344 in vertical direction. The third means 304 preferably has a disk element 365, a fixing body 363, an inner cover element 362, a screw nut 360, a washer 359, ball bearing 358 and/or one or a plurality of accommodating sleeves 355, by means of which the axle or shaft 357, respectively, can preferably be brought into an operative connection with the grinding ring 344.

The first means 302, the second means 303 and/or the third means 304 are preferably oriented substantially or exactly parallel to one another, wherein at least one of these means 302, 303, 304 is preferably also oriented substantially or exactly parallel to a rotational axis of a comminuting element.

A fourth means for fixing and/or power transmission is furthermore identified by reference numeral 307. The fourth means 307 preferably serves to orient or hold, respectively, the rotational body 345, 380 with respect to the grinding ring 344. It is also possible, however, that the fourth means 307 has a drive unit for actively driving the or a rotational body 345, 380, respectively, or is coupled to such a drive unit, respectively. The fourth means 307 can preferably be identified as axle or shaft 351 and preferably has an outer cover element 354, a fixing unit 366, an inner cover element 352, a spacer element 348 for accommodating and/or spacing apart the axles 347, ball bearing cover elements 348, axles 347 and/or ball bearings 346. The rotational bodies 345, 380 are thus rotationally supported by means of the bearings 346.

A perspective detailed illustration of parts of the second pulverizer 301 is illustrated in FIG. 15. According to this illustration, the second pulverizer 301 has a rotational body, which is formed as grinding ring 344, which radially encloses two further rotational bodies 345, 380, which are formed as drum-like grinding elements or grinding drums, respectively, at least in sections and preferably completely. Axially, the grinding ring 344 and the grinding drums 345, 380 preferably have substantially the same length, whereby it is also possible that the grinding drums 345, 380 are formed so as to be axially longer than the grinding ring 344 or vice versa, respectively. The grinding drums 345, 380, which are preferably formed spherically, in particular so as to taper conically starting at their substantially axial center to their axial ends, preferably have an outer surface 383. The inner surface 383 of the grinding ring 344 is preferably embodied cylindrically, whereby it is also possible that it is formed negatively or substantially negatively to the outer surface 383 of the grinding drums 345, 380. The outer surface 384 of the grinding ring 344 is preferably formed cylindrically. Preferably exactly three means 302, 303, 304 for fixing and/or transmitting power, are preferably in a line contact and particularly preferably in a surface contact with the outer surface 384 of the grinding ring 344, in particular in each case via an element 55 for guiding the grinding ring 344.

Reference numeral 348 preferably identifies a bearing cover, which preferably radially covers the drum body of the grinding drum 380 and the bearing, which is preferably formed as ball bearing, preferably consisting of at least or exactly two ball bearings 346 (see FIG. 14) at least in sections, in particular covers it in such a manner that the bearing is protected against the inflow of ore powder.

The rotational axes of the two grinding drums 344, 380 are preferably arranged spaced apart from one another by a spacer element 349. The spacer element 349 is preferably formed as strut-shaped, in particular plate-shaped, accommodating element, in particular of metal. Next to the grinding drums 345, 380, a fixing body 366 is preferably also arranged on the spacer element 349 or is coupled to the spacer element 349, respectively. The fixing body 366 can hereby be provided for the one-sided attachment of the grinding drum unit 345, 380, 349 to a housing part (not shown), in particular a further housing wall. It is also possible, however, that the fixing body 366 is formed as drive unit 366 and serves to actively drive the grinding drums 344, 380.

The first means for fixing and power transmission 302 and the second means for fixing and power transmission 303 have gearwheels 367, which are connected to one another by means of a chain 360. It can furthermore be seen that the second means for fixing and power transmission 303 is also equipped with a round disk-like power transmission plate 368, which is formed radially for accommodating a belt 372, by means of which the second means for fixing and power transmission 302 is coupled to a further round power transmission plate 368, which, in turn, is connected to a drive unit 370, in particular a motor, for operating the second pulverizer 301.

FIG. 16 illustrates a sectional illustration through the ore comminuting device 290 according to the invention. The device housing 3, which is held by means of bases 6 with respect to a ground or an accommodating frame, respectively (see FIG. 19 or FIG. 20a/b) can be gathered from this illustration. The housing 3 preferably completely encloses the second pulverizer 301 in circumferential direction. A plurality of holding units, in particular exactly three holding units, namely a first holding unit 402, a second holding unit 403 and a third holding unit 404, are preferably arranged on the inner surface of the housing 3 or on the surface side of the housing, which faces the second pulverizer 301, respectively. The holding units 402, 403, 404 preferably serve to position or hold, respectively, drive and/or guide elements 355. The drive and/or guide elements 355 are preferably rollers, which are rotatably arranged on the holding units 402, 403, 404. Preferably, at least one of the drive and/or guide elements 355 is driven by means of a motor. Particularly preferably, two or all drive and/or guide elements 355 are driven, in particular by means of a motor or in each case by means of one motor. The drive and/or guide elements 355 serve to drive and/or guide the grinding ring 344. The grinding ring 344 is preferably adjoined by the housing wall 406. The housing wall 406 preferably has a central opening 382, which is provided for the guide-through of a drive unit, in particular a shaft, for driving the first pulverizer 300, in particular the comminuting element 30 (see FIG. 6 and FIG. 17). A feeding unit 408 is furthermore formed in the housing wall 406 or the feeding unit 408 is preferably formed in a tubular manner, respectively, and extends through the wall 406. The feeding unit 408 preferably serves to feed material, which has already been pulverized by means of the first pulverizer 300. The feeding unit 408 preferably extends inside the housing 3 or into an area, which is enclosed by the grinding ring 344, respectively, in such a manner that the material fed by means of the feeding unit 408 is introduced upstream of the first grinding drum 345. The grinding ring 344 preferably rotates in the direction identified by means of reference numeral R, whereby the material introduced upstream of the first grinding drum 345 is conveyed between the grinding ring 344 and the grinding drum 345. By means of the cooperation of grinding ring 344 and grinding drum 345, the material is further comminuted or pulverized, respectively, A second grinding drum 380 is furthermore shown, it is thus possible that a plurality of grinding drums 345, 380 are used. It is preferably possible that any number of grinding drums 345, 380, in particular exactly, more or less than one, two, three, four or five grinding drums, are used. The individual grinding drums 345, 380 are preferably rotatably driven and particularly preferably actively by means of a drive unit. It is furthermore possible that the grinding drums 345, 380 are only passively driven or rotated, respectively, i.e. as a result of a rotation of the grinding ring 344. The grinding drums 345, 380 are preferably arranged on the housing wall 406 via spacer elements 349 for accommodating the grinding drums 345, 380 via coupling locations 412. It is possible hereby that the positions of the grinding drums 345 380 can be changed or adjusted, respectively, by means of the spacer elements 349. Preferably, the distance, in particular a maximum distance, of the outer grinding drum surface to the inner grinding ring surface can be adjusted.

It is furthermore possible that the grinding drums 345, 380 or one of the grinding drums 345, 380 is spring-loaded or is pressed or pretensioned, respectively, against the grinding ring.

An ore comminuting device 290, which, as compared to FIG. 6a, is expanded by the second pulverizer 301, is shown in FIG. 17. The ore comminuting device 290 has a feed funnel 1, via which coarse material to be comminuted can be introduced into the device. The material is comminuted by means of the first pulverizer 300, in particular by means of the cooperating elements 30, 40, i.e. the comminuting element 30 and the fixed element 40. The comminuted materials are moved out of the area between the elements 30, 40, in particular by means of the force of gravity, and reach into the funnel 14. The elements 30, 40 are preferably arranged at a distance of substantially, exactly or maximally 7 cm and further preferably at a distance of substantially, exactly or maximally 5 cm and particularly preferably at a distance of substantially, exactly or maximally 3.5 cm relative to one another. It is possible hereby that the distance between the elements 30, 40 can be adjusted, in particular varied. Particularly preferably, the distance between the elements 30, 40 can be adjusted continuously or in predefined steps. The funnel 14 guides the comminuted material via a pump unit 410 into a separator or into a separation unit 413, respectively, according to the arrow T1. The separator 413 separates sufficiently comminuted material fractions from insufficiently comminuted material fractions, in particular in a cyclone-like manner. The insufficiently comminuted material fractions, which were separated from the sufficiently comminuted material fractions by means of the separator 413, are discharged from the separator 413 via a first outlet opening 414 or branch and are fed to an introduction unit 408 according to the conveying line identified by reference numeral T2 (see FIG. 16). The introduction unit 408 is preferably mounted in the area of the wall 406 and serves to introduce the material fractions, which are to be further comminuted, into the second pulverizer 301. In addition or as an alternative, it is also possible that the further material fractions to be comminuted are fed to the first pulverizer 300 once again. Reference numeral 416 identifies a second outlet opening or a further branch, respectively. The sufficiently pulverized ore can be discharged or conveyed away, respectively, from the area of the device 290 by means of the second outlet opening 416 or by means of the further branch, respectively, according to the conveying line T3, wherein the ore is preferably directly conveyed or guided, respectively, to a floatation unit. It is furthermore possible that the separator 413 has three outlet units and assigns the comminuted material to three material size areas, wherein the material, which has already been sufficiently comminuted, is conveyed further according to T3 and the insufficiently comminuted material is divided into a coarse and a fine fraction. The coarse fraction can then be guided to the first pulverizer 300 once again and the fine fraction can be fed to the second pulverizer 301, in particular according to T2.

The sufficiently comminuted, in particular pulverized material fractions, are discharged from the ore comminuting device via the arrow, which is identified with reference numeral T3, and are particularly preferably fed directly to a floatation unit.

It can be gathered from this illustration that at least two shafts 357, 371 are provided. The shafts 357, 371 serve to drive the elements for guiding and/or driving 355. The individual shafts 357, 371 are preferably connected to drive units 304. Provision is furthermore particularly preferably made for a third shaft (see FIG. 14) for driving a third element for guiding and/or driving 355 (see FIG. 15).

The grinding drums 345, 380, which are enclosed by the grinding ring in circumferential direction, are furthermore illustrated.

The hydraulic spring pressure unit 604 has the effect that a force of several tons is axially applied to the shaft 21 and thus to the comminuting means 30. This means that an axial displacement of the shaft 21 in X-direction only takes place when, e.g. as a result of a material accumulation between the comminuting elements 30, 40 or through the ramp area 31, forces are generated, which are directed in X-direction and which exceed the spring force. The hydraulic spring pressure unit 604 thus has the advantageous effect that the shaft 21 and the comminuting elements 30, 40 are only subjected to a predetermined or adjusted maximum force, respectively, in X-direction, whereby these elements are protected against being damaged. The displacement path S1 of the shaft 21 as a result of a deflection of the hydraulic spring pressure unit 604 is preferably in the range of between a few or some millimeters, respectively, and several or some centimeters, respectively.

It is further possible that the spring force can be adjusted or predetermined, respectively, in such a manner that defined ore particle sizes can be produced. The smaller the spring force, the larger the resulting ore particle sizes.

The spring force can preferably be adjusted in a stepless or continuous manner, respectively, or in steps.

Reference numerals 506 and 508 identify ball bearings, by means of which the shaft 21 is preferably supported. The ball bearings 506 are preferably formed as ball bearings and the ball bearings 508 are preferably formed as conical bearings or needle bearings.

The embodiment shown in FIG. 17 is shown in an opened configuration in FIG. 18. In this configuration, preferably at least the comminuting element 30 and preferably the entire interior of the device 290 can be accessed by a human for maintenance work. The housing cover 420 is thereby moved into the opened position by means of an actuator 434 or by means of a plurality of actuators, respectively, in particular exactly two actuators 434, of a hydraulic unit (see FIG. 21a/b).

FIG. 19a shows a transport unit 386 in a top view, on which a comminuting device 290 according to the invention is arranged. The transport unit 386 is preferably formed as trailer, which can be pulled by a motor vehicle. For this purpose, the transport unit 386 has a frame 388, on which the comminuting unit 290 is preferably arranged in a permanent manner. It is also possible, however, that the comminuting unit 290 is releasably coupled to the transport unit 386. Preferably at least or exactly two wheels for each axle are arranged on the frame 388. In the illustrated embodiment, the transport unit 386 has exactly one axle, whereby it is possible that it has a plurality, in particular two or three axles. The transport unit 386 can be coupled to a motor vehicle or a further trailer via the coupling location 392.

A side view of the illustration shown in FIG. 19a is illustrated in FIG. 19b.

In FIG. 20, the comminuting device 290 according to the invention is arranged on a frame 393. As an alternative, however, the comminuting device 290 can be arranged on a scaffolding or a platform instead of on a frame 393. The arrangement shown in FIG. 20 is advantageous, because the discharge area 394, from which the comminuted material is discharged, can be easily accessed due to the distance between the comminuting unit 290 and the ground.

Reference numerals 450, 452 furthermore identify the drive units or motors, respectively, via which the rotational ring body 344 (see FIG. 15) can be driven.

FIG. 21a shows the device 290 according to the invention in a closed configuration. In this closed configuration, the housing cover 420, which is preferably connected to the feed funnel 1, rests against the housing 3, in particular so as to form a seal. The housing cover 420 is preferably held by means of a closing unit 430, which is particularly preferably formed as hydraulic unit, and is preferably pressed against the housing 3. The hydraulic unit 430 preferably has a stator 432, which is particularly preferably arranged in the area of the housing 3 or on the housing 3. The stator 430 is preferably coupled to an actuator 434 in such a manner that it can be displaced in the direction of extension of the rotational axis of the comminuting element 30. Such a hydraulic unit 430 is preferably arranged on both sides of the housing 3. It is furthermore possible that said hydraulic units are also arranged in the area of the upper and lower wall area of the housing 3. It is also possible that more than two, in particular three or four hydraulic units 430 are provided, in particular in the upper and lower housing area and in the lateral housing areas. In the case of a plurality of hydraulic units 430, they can preferably be driven at the same time, in particular via a control unit. The actuator 434 is preferably connected or coupled, respectively, to the housing cover 420 via an actuator housing cover coupling location 436.

The device 290 is illustrated in an open or opened configuration, respectively, in FIG. 21b. The open or opened configuration, respectively, is characterized in that the housing cover 420 is removed or spaced apart, respectively, from the housing 3 at least in sections. Such spacing can take place as illustrated, i.e., the housing cover 420 can be spaced apart as a whole from the housing 3, preferably by a certain distance. The spacing is preferably carried out by means of one or a plurality of hydraulic units 432. It is also possible, however, that the housing cover 420 rests against the housing 3 on the one side and is pivoted about the contact point by means of the closing unit or hydraulic unit 430, respectively.

The feed funnel 1 and the comminuting element 40 is preferably arranged on the housing cover 420. The ore to be fed can be filled into the closed housing 3 (see FIG. 21a) by means of the feed funnel 1, preferably through the housing cover 420 and through the comminuting element 40.

A human identified with reference numeral 500 can furthermore be gathered from the illustration in FIG. 21b. It can further be gathered from this illustration that the housing cover 420 comprising the units arranged thereon, in particular the comminuting element 40 can be moved by means of the hydraulic unit 432, particularly preferably to the extent that a human 500 can enter the device 290 through the opening 502 resulting from the housing cover displacement or can service individual or all components therein, respectively. Wear elements, such as, e.g. the ramp area 31, the protrusions 35, the protrusions 45 of the two comminuting elements 30, 40 (see FIG. 8) can thereby be replaced as maintenance operations.

In addition or in the alternative, the hydraulic unit 432 can serve as spring unit for variably supporting the comminuting element 40.

The device according to the invention also has procedural advantages in the dry and/or in the wet method. In particular the process-independence on water is important in this context. The device according to the invention works dry as well as wet—an advantage, which the process chain of crushers and grinders must differentiate on the basis of the function. The micro impact grinder also comminutes slag or a mixture of slag and ore material, which overburdens the comminuting technology of classical systems due to the hardness of the material.

It is further advantageous that this device can process rocks and/or slag. Even bricks of blast furnaces do not affect it. With regard to the performance range, the device according to the invention can even replace the entire process chain consisting of a plurality of crushers and ball mills. Chunks of rocks of preferably up to 80 cm, more preferably up to 50 cm and particularly up to 40 cm are processed in a process step so as to be directly suitable for floatation. This is opposed by a plurality of comminuting steps by means of crushers, until a ball mill then performs its duty.

In particular, only a low wear results in the case of the device according to the invention by means of the micro impact, that is, by means of the repeated meeting of differently accelerated ore, whereby the mechanical elements are impacted only slightly, wherein no additional loose grinding elements or iron balls need to be used.

The device according to the invention and the method according to the invention also makes it possible that slag can be comminuted and pulverized by itself or together with ore material, because, due to the small dimensioning of the comminuting space as well as due to the comminuting elements, which are dimensioned so as to be relatively small, high forces act on the ore material to be comminuted or on the slag to be comminuted, respectively, by means of a corresponding rotation and an effective pulverization thus takes place. Due to the rotation, which, due to the dimensions, can have between 100 and approximately 2000 revolutions per minute of a comminuting element, slag, which is very brittle and has a hard structure, can also be pulverized effectively.

The raw material productivity as well as the conservation of resources can be improved by means of the device according to the invention. In particular the pre-comminution with crushers and mills—is eliminated with this innovation in a highly energy-efficient and ecological manner. This innovative device is further advantageous, because it combines energy with resource efficiency and, at the same time, provides a completely new human-machine cooperation entirely without silicosis and noise-induced hearing loss.

The invention thus refers to a device for comminuting ore material and/or of slag, which comprises an ore feeding unit for feeding ore to be comminuted, to a first pulverizer, wherein the first pulverizer is composed of at least two comminuting elements, which can be moved relative to one another and which, together, form at least one comminuting space for the ore to be comminuted such that, by a relative movement in the form of a rotation about the rotational axis of at least one of the two comminuting elements, the ore to be comminuted is at least partially pulverized in that provision is made on at least one of the comminuting elements for one or a plurality of accelerating elements, in particular protrusions, which are in particular arranged on the end face of one of the two comminuting elements and which accelerate and comminute the ore to be comminuted by the rotation of one of the two comminuting elements, and wherein provision is made between the two comminuting elements and/or in at least one of the two comminuting elements for an intermediate space, through which the pulverized ore is transported from the center of rotation toward the outside and away from the two comminuting elements during the rotation and wherein at least one of the two comminuting elements is operatively connected to a hydraulic spring pressure unit, wherein the hydraulic spring pressure unit is designed in such a manner that it supports the comminuting element, to which it is operatively connected, in a variable resilient manner in the direction of the other comminuting element, depending on an adjustable hydraulic spring pressure control unit.

### LIST OF REFERENCE NUMERALS

1 feed funnel

2 base

3 housing

4 suction opening

6 base

8 motor

9 belt pulley

10 belt

11 drive roller

14 outlet funnel

15 control flap

21 shaft

30 comminuting element

31 ramp area

33 ramp end

35 protrusions

36 recess

40 fixed element

41 feed opening

42 annular area

45 protrusion

46 recess

50 clumps of ore

51 ore particles

52 ore particles

55 pulverized ore

60 intermediate space

61 outlet recesses

62 outlet recesses

140 fixed element

141 fixed element

143 accelerating element

144 angle area

145 recess

162 outlet recesses

230 rotary element

236 recess

240 fixed element

241 feed opening

260 intermediate space

290 comminuting device

300 first pulverizer

301 second pulverizer

302 first means for fixing and power transmission

303 second means for fixing and power transmission

304 third means for fixing and power transmission

305 frame element

306 housing wall

307 fourth means for fixing and/or power transmission

313 first lower shaft for fixing and/or driving the grinding ring

344 grinding ring

345 first grinding drum

346 ball bearing

347 axle

348 ball bearing cover element

349 spacer element for accommodating and spacing the axles 347

350 fixing the spacer element

351 axle

352 inner ball bearing cover element

354 fixing location

355 element for guiding and/or driving the grinding ring

356 means for securing an axle

357 upper shaft for fixing and/or driving the grinding ring (or the axle, respectively)

358 ball bearing for supporting the grinding drum

359 washer

360 screw nut

361 stop for fixing the grinding ring

362 inner cover element

363 upper fixing body for fixing the grinding ring

364 disk element for fixing a lower axle supporting the grinding ring

365 disk element for fixing an upper axle supporting the grinding ring

366 lower fixing body for fixing the grinding ring

367 drive wheel

368 round disk-like power transmission plate

369 drive chain

370 motor

371 second lower shaft for fixing and/or driving the grinding ring

372 belt

380 second grinding drum

381 fixing location

382 opening

383 outer surface of the grinding drum

384 outer surface of the grinding ring

385 inner surface of the grinding ring

386 transport unit

388 frame

390 wheels

392 coupling location

393 frame

394 discharge area

402 first holding unit

403 second holding unit

404 third holding unit

406 wall

408 introduction direction

410 pump unit

412 coupling location to wall

413 separation unit

414 first outlet opening in the separator

416 second outlet opening in the separator

419 line section

420 housing cover

430 hydraulic unit

432 stator

434 opening unit

436 actuator-housing cover coupling

450 first additional drive

452 second additional drive

500 human

502 opening

506 ball bearing

507 support unit

508 ball bearing

520 feed connection

521 axial end of the shaft

604 hydraulic spring pressure unit

R rotational direction of the grinding ring

S1 displacement path

T1 first transport direction

T2 second transport direction

T3 third transport direction

X direction

1.-9. (canceled)

10. A device for comminuting ore material and/or slag comprising:
an ore feeding unit for feeding ore to be comminuted to a first pulverizer, wherein the first pulverizer is composed of at least two comminuting elements, which can be moved relative to one another and which, together, form at least one comminuting space for the ore to be comminuted such that, by a relative movement in the form of a rotation about the rotational axis of at least one of the two comminuting elements, the ore to be comminuted is at least partially pulverized in that provision is made on at least one of the comminuting elements for one or a plurality of accelerating elements, in particular protrusions, which are in particular arranged on the end face of one of the two comminuting elements and which accelerate and comminute the ore to be comminuted by the rotation of one of the two comminuting elements;
wherein provision is made between the two comminuting elements and/or in at least one of the two comminuting elements for an intermediate space, through which the pulverized ore is transported from the center of rotation toward the outside and away from the two comminuting elements during the rotation; and
wherein at least one of the two comminuting elements has an operative connection with a hydraulic spring pressure unit, wherein the hydraulic spring pressure unit is designed in such a manner that it supports the comminuting element, to which it is operatively connected, in a variable resilient manner in the direction of the other comminuting element, depending on an adjustable hydraulic spring pressure control unit.

11. The device according to claim 10 wherein:
at least one of the comminuting elements is arranged on a shaft for driving the comminuting element;
wherein the hydraulic spring pressure unit is directly coupled to the shaft or the comminuting element and is pretensioned by said shaft; and
wherein the shaft and the comminuting element arranged thereon can be displaced against the spring force of the hydraulic spring pressure unit.

12. The device according to claim 11 wherein a displacement of the shaft and of the comminuting element takes place as a function of the pretensioning of the hydraulic spring pressure unit, wherein the hydraulic spring pressure unit deflects during the operation of the first pulverizer as a result of a deflection force, which is generated between the two comminuting elements and which is directed against a contact pressure resulting from the spring force of the hydraulic spring pressure unit, when the deflection force exceeds the contact pressure.

13. The device according to claim 11 wherein the shaft is supported in a housing of the device by means of ball bearings and is coupled to a drive unit for rotating the shaft and the comminuting element arranged thereon.

14. The device according to claim 11 wherein the hydraulic spring pressure unit is arranged in an end area of the shaft, wherein the end area is axially spaced apart from a second end area of the shaft, on which the comminuting element is arranged.

15. The device according to claim 10 wherein the hydraulic spring pressure unit adjusts the spring force of the hydraulic spring pressure unit within a range of between 100 ms and 1 ms, preferably within a range of between 20 ms and 2 ms, further preferably within a range of between 10 ms and 3 ms and particularly preferably within a range of between 7 ms and 3 ms by means of the adjustable hydraulic spring pressure control unit so as to be variable in the amplitude, in particular in an oscillating manner.

16. The device according to claim 10 wherein the hydraulic spring pressure unit has a plurality of hydraulic suspension means, wherein the individual hydraulic suspension means are arranged in such a manner that they push the comminuting element, which is coupled to the shaft, in the direction of the other comminuting element.

17. The device according to claim 10 wherein a comminuting element is arranged on a housing cover, which at least temporarily closes a housing of the device in the direction of extension of the rotational axis, wherein the housing cover can be moved with respect to the device and wherein the fixedly arranged comminuting element is pressed against the other comminuting element by means of an opening unit, which connects the housing cover to the device.

18. A method for comminuting ore material and/or of slag with an ore feeding unit for feeding ore to be comminuted to a first pulverizer, wherein the first pulverizer is composed of at least two comminuting elements, which can be moved relative to one another and which, together, form at least one comminuting space for the ore to be comminuted such that, by a relative movement in the form of a rotation about the rotational axis of at least one of the two comminuting elements, the ore to be comminuted is at least partially pulverized in that provision is made on at least one of the comminuting elements for one or a plurality of accelerating elements, in particular protrusions, which are in particular arranged on the end face of one of the two comminuting elements and which accelerate and comminute the ore to be comminuted by the rotation of one of the two comminuting elements, and wherein provision is made between the two comminuting elements and/or in at least one of the two comminuting elements for an intermediate space, through which the pulverized ore is transported from the center of rotation toward the outside and away from the two comminuting elements during the rotation, and wherein at least one of the two comminuting elements has an operative connection with a hydraulic spring pressure unit, wherein the hydraulic spring pressure unit is designed in such a manner that it supports the comminuting element, to which it is operatively connected, in a variable resilient manner in the direction of the other comminuting element, depending on an adjustable hydraulic spring pressure control unit.
